(19) United States
(12) Patent Application Publication
(10) Pub. No.: US 2025/0193752 A1
(43) Pub. Date: Jun. 12, 2025

(54) METHOD FOR ALLOCATING MEASUREMENT OCCASIONS, A COMPUTER PROGRAM PRODUCT, A PROCESSING UNIT, AND A WIRELESS DEVICE

(71) Applicant: BEAMMWAVE AB, Lund (SE)

(72) Inventors: Joakim Axmon, Limhamn (SE); Bengt Lindoff, Bjärred (SE)

(21) Appl. No.: 18/842,717

(22) PCT Filed: Mar. 7, 2023
(86) PCT No.: PCT/SE2023/050208

§ 371 Date: Aug. 29, 2024

(30) Foreign Application Priority Data
Mar. 11, 2022 (SE) 2230070-1

(51) Int. Cl. H04W 36/00; H04B 17/318; H04W 76/20

(52) U.S. Cl. CPC H04W 36/0088; H04B 17/328; H04W 36/0058; H04W 76/20

(57) ABSTRACT

A method for a processing unit, the processing unit being associated with and able to control a plurality of transceivers, the method comprising: obtaining a configuration associated to measurement instances for a first transceiver node; obtaining a number (N) indicative of how many measurement instances are available for the first transceiver node; allocating for each of the available measurement instances a subset or no subset of the plurality of transceivers, based on the obtained number (N); and performing at each measurement instance, the measurements relating to the subset allocated to the measurement instance. Corresponding computer program product, processing unit, and wireless device are also disclosed.

### TECHNICAL FIELD

The present disclosure relates to a method for allocating measurement occasions, a computer program product, a processing unit, and a wireless device.

More specifically, the disclosure relates to a method for allocating measurement occasions, a computer program product, a processing unit, and a wireless device as defined in the introductory parts of the independent claims.

### BACKGROUND ART

Digital beamforming (BF) management for a wireless device (WD) comprises at least antenna selection and digital BF. Antenna selection relates to updating of a set of active antennas (and transceivers associated with the active antennas) based on measurements on synchronization signals such as synchronization signal blocks (SSBs) transmitted in SSB bursts at SSB occasions (and/or channel state information reference symbols, CSI-RS, during time periods without SSB reception) for 5G-NR and the active antenna/transceiver set is thereafter utilized for digital BF on various physical channels and/or CSI-RSs during time periods without SSB reception. An example of digital BF can be found in U.S. Pat. No. 9,054,845 B2.

The WD supports mobility, measurements on neighbour transmission (TX) beams (e.g., Transmission Configuration Indicator, TCI, states) and intra/inter frequency neighbour cell/area and TX beams. Furthermore, the WD receives configured time pattern for SSB monitoring from a base station (BS), such as an eNB or a gNB, and manages multiple/main active transceiver/antenna set, Mu/Ma-ATS/AAS and multiple virtual active transceiver/antenna set Mu-VAAS/VATS for a respective active cell/area/TCI and a respective configured handover (HO) candidate.

However, there could be several HO candidates to monitor with different transceiver sets, thus the radio resource management (RRM) may be power consuming. Therefore, there may be a need for a method and/or an apparatus with a better (such as optimized) trade-off between measurement performance and power consumption.

### SUMMARY

An object of the present disclosure is to mitigate, alleviate or eliminate one or more of the above-identified deficiencies and disadvantages in the prior art and solve at least the above-mentioned problem.

According to a first aspect there is provided a method for a processing unit, the processing unit configured to control a plurality of transceivers, the processing unit and the plurality of transceivers (500, 501, . . . , 515) are comprisable in a wireless device (WD), the method comprises: obtaining a configuration associated to measurement occasions during which the WD 420 can perform measurements for a first transceiver node; obtaining a number indicative of how many measurement occasions, during which the WD 420 can perform measurements for the first transceiver node, are available; allocating for each of the available measurement occasions a subset of the plurality of transceivers, based on the obtained number; and performing at each available measurement occasion, the measurements relating to the subset allocated to the available measurement occasion. Furthermore, one or more allocated subsets are empty, and reception for measurements is turned off for all of the plurality of transceivers during one or more of the available measurement occasions for which the allocated subset is empty. By allocating for each of the available measurement occasions (only) a subset of the plurality of transceivers, reception for measurements can be turned off and thus power consumption can be reduced. In some embodiments, turning off reception for measurements for a transceiver comprises turning off one or more front end transceivers associated with (e.g., connected, or connectable to) the same transceiver. Alternatively, or additionally, turning off reception for measurements for a transceiver comprises turning off one or more of a low noise amplifier (LNA), a variable gain amplifier (VGA), a phase locked loop (PLL), a power amplifier (PA), a local oscillator (LO), and a mixer, all associated with the (same) transceiver, e.g., turning off the low noise amplifier (LNA), the variable gain amplifier (VGA), local oscillator (LO), and a mixer and the power amplifier (PA). E.g., reception for measurements can be turned off during one or more of the (available) measurement occasions if no measurements are allocated during the one or more of the (available) measurement occasions. I.e., reception for measurements can be turned off during one or more of the (available) measurement occasions if the subset(s) allocated for the one or more measurement occasions are empty. Furthermore, power/energy efficient measurement for radio resource management (RRM) and beam management is achieved.

Moreover, better/more accurate measurement performance is achieved and/or measurement performance is adapted to transceiver node priority thereby increasing power efficiency and/or measurement accuracy. In some embodiments, all transceivers of the plurality of transceivers 500, 501, . . . , 515 not belonging to any of the subsets allocated to the available measurement occasions are turned off during all the measurement occasions during which the WD 420 can perform measurements for the first transceiver node 422, 802, 804, 806, 808. Thus, power consumption is reduced. Moreover, in some embodiments, reception for measurements is turned off for all of the plurality of transceivers 500, 501, . . . , 515 during each of the available measurement occasions for which the allocated subset is empty.

According to some embodiments, the measurement occasions are one of: synchronization signal block, SSB, index time occasions; channel state information, CSI-RS, time occasions; and demodulation reference signal, DM-RS, time occasions.

According to some embodiments, the first transceiver node is any one of: a serving base station (BS) for a deactivated secondary cell (SCell), a serving BS associated with a configured TCI state; a handover, HO, candidate BS; and a serving BS associated with an active Transmission Configuration Indicator (TCI) state.

According to some embodiments, the number indicative of how many measurement occasions, during which the WD 420 can perform measurements, are available for the first transceiver node is obtained from one or more of: a pre-defined rule, wherein the pre-defined rule is based on a transceiver node type of the first transceiver node; and a configuration obtained from a second transceiver node.

According to some embodiments, allocating for each of the available measurement occasions a subset of the plurality of transceivers is further based on one or more of: a signal quality/strength measurement for a subset of the plurality of transceivers; a transceiver node type; power consumption constraints; and data interface rate constraints.

According to some embodiments, a size of a subset of the plurality of transceivers is based on one of: a signal quality/strength measurement for a subset of the plurality of transceivers; a transceiver node type; power consumption constraints; and data interface rate constraints.

According to some embodiments, the method further comprises transmitting a measurement report to the second transceiver node, the measurement report comprising a signal quality/strength measurement value, such as signal quality/strength measurements for each transceiver of a first subset of the plurality of transceivers combined into one signal quality/strength measurement value.

According to some embodiments, all transceivers of the plurality of transceivers not belonging to any of the subsets allocated to the available measurement occasions are turned off during all the measurement occasions during which the WD 420 can perform measurements for the first transceiver node.

According to some embodiments, reception for measurements is turned off for all of the plurality of transceivers during each of the available measurement occasions for which the allocated subset is empty.

According to a second aspect there is provided a computer program product comprising instructions, which, when executed on at least one processor of a processing device, cause the processing device to carry out the method according to the first aspect or any of the above-mentioned embodiments when the computer program is run by the data processing unit.

According to a third aspect there is provided a non-transitory computer-readable storage medium storing one or more programs configured to be executed by one or more processors of a processing device, the one or more programs comprising instructions which, when executed by the processing device, causes the processing device to carry out the method according to the first aspect or any of the above-mentioned embodiments when the computer program is run by the data processing unit.

According to a fourth aspect there is provided a processing unit, the processing unit being associated with and able to control a plurality of transceivers, the processing unit being configured to: obtain a configuration associated to measurement occasions for a first transceiver node; obtain a number indicative of how many measurement occasions are available for the first transceiver node; allocate, for each of the available measurement occasions, a subset of the plurality of transceivers based on the obtained number; and perform, at each measurement occasion, the measurements relating to the subset allocated to the measurement occasion.

According to a fifth aspect there is provided a wireless device (WD) comprising the processing unit of the fourth aspect and the plurality of transceivers.

According to a sixth aspect there is provided a chip comprising the processing unit of the fourth aspect.

Effects and features of the second, third, fourth, fifth, and sixth aspects are fully or to a large extent analogous to those described above in connection with the first aspect and vice versa. Embodiments mentioned in relation to the first aspect are fully or largely compatible with the second, third, fourth, fifth, and sixth aspects and vice versa.

An advantage of some embodiments is that power consumption is reduced or optimized (for the wireless device).

Another advantage of some embodiments is that for each or some of the available measurement occasions a subset of the plurality of transceivers reception for measurements can be turned off and thus power consumption can be reduced.

Yet another advantage of some embodiments is that more power/energy efficient measurements for RRM and/or beam management may be obtained.

Yet a further advantage of some embodiments is that energy efficiency is increased or improved.

A further advantage of some embodiments is that better/more accurate measurements are obtained.

Yet another advantage is that measurement performance is adapted to transceiver node priority thereby increasing power efficiency and/or measurement accuracy.

The present disclosure will become apparent from the detailed description given below. The detailed description and specific examples disclose preferred embodiments of the disclosure by way of illustration only. Those skilled in the art understand from guidance in the detailed description that changes, and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claims, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1 is a schematic drawing illustrating method steps according to some embodiments;

FIG. 2 is a schematic drawing illustrating a computer readable medium according to some embodiments;

FIG. 3 is a flowchart illustrating method steps implemented in a processing unit according to some embodiments;

FIG. 4 is a schematic drawing illustrating a processing unit which may be comprised in a wireless device according to some embodiments; and

FIG. 5 is a schematic drawing illustrating which transceivers are utilized for measurements during different measurement occasions according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### Terminology

Below is referred to millimeter Wave (mmW) operation, mmW communication, mmW communication capability and mmW frequency range. The mmW frequency range is from 24.25 Gigahertz (GHz) to 71 GHz or more generally from 24 to 300 GHz. MmW may also be referred to as Frequency Range 2 (FR2).

Below is referred to a processor/processing unit. The processor may be a digital processor. Alternatively, the processor may be a microprocessor, a microcontroller, a central processing unit, a co-processor, a graphics processing unit, a digital signal processor, an image signal processor, a quantum processing unit, or an analog signal processor. The processing unit may comprise one or more processors and optionally other units, such as a control unit.

Below is referred to a wireless device (WD). A wireless device is any device capable of transmitting or receiving signals wirelessly. Some examples of wireless devices are user equipment (UE), mobile phones, cell phones, smart phones, Internet of Things (IoT) devices, vehicle-to-everything (V2X) devices, vehicle-to-infrastructure (V2I) devices, vehicle-to-network (V2N) devices, vehicle-to-vehicle (V2V) devices, vehicle-to-pedestrian (V2P) devices, vehicle-to-device (V2D) devices, vehicle-to-grid (V2G) devices, fixed wireless access (FWA) points, and tablets.

Below is referred to a “transceiver node” (TNode). A TNode may be a remote radio unit (RRU), a repeater, a remote wireless node, or a base station (BS), such as a radio base station (RBS), a Node B, an Evolved Node B (eNB) or a gNodeB (gNB). Furthermore, a TNode may be a BS for a neighbouring cell, a BS for a handover (HO) candidate cell, a remote radio unit (RRU), a distributed unit (DU), another WD or a base station (BS) for a (activated/deactivated) secondary cell (SCell) or for a serving/primary cell (PCell, e.g., associated with an active TCI state).

Below is referred to a digital interface. A digital interface is a unit converting analog signals from e.g., transceivers to digital signals, which digital signals are conveyed to e.g., a baseband processor, and/or converting digital signals from e.g., a baseband processor to analog signals, which analog signals are conveyed to e.g., one or more transceivers. A digital interface may also comprise filters and other pre-processing functions/units.

Below is referred to an antenna unit. An antenna unit may be one single antenna. However, an antenna unit may also be a dual antenna, such as a dual patch antenna with a first (e.g., horizontal) and a second (e.g., vertical) polarization, thus functioning as two separate antennas or an antenna unit having two ports.

Below is referred to a chip. A chip is an integrated circuit (chip) or a monolithic integrated circuit (chip) and may also be referred to as an IC, or a microchip.

Below is referred to an active transceiver. An active transceiver is a transceiver, which is utilized or ready to be utilized for transmission and/or reception, e.g., configured for transmission and/or reception or e.g., not in a (deep) sleep mode.

Below is referred to a Transmission Configuration Indicator (TCI) State. A TCI state contains parameters for configuring a quasi-co-location relationship between one or two downlink reference signals and the Demodulation reference signal (DM-RS) ports of the physical downlink shared channel (PDSCH), the DM-RS port of physical downlink control channel (PDCCH) or the channel state information reference signal (CSI-RS) port(s) of a CSI-RS resource.

Below is referred to an active TCI state. An active TCI state is the TCI state of a presently active transmit beam of a network node. In some standards, such as 3GPP standards, an active TCI state may be expressed as “indicated” (among potentially more than one “active” TCI state).

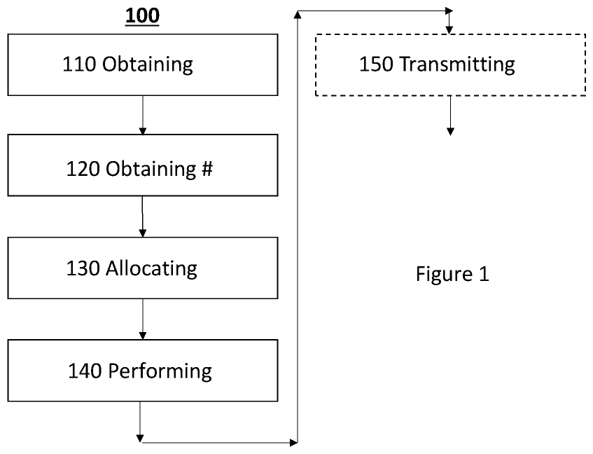

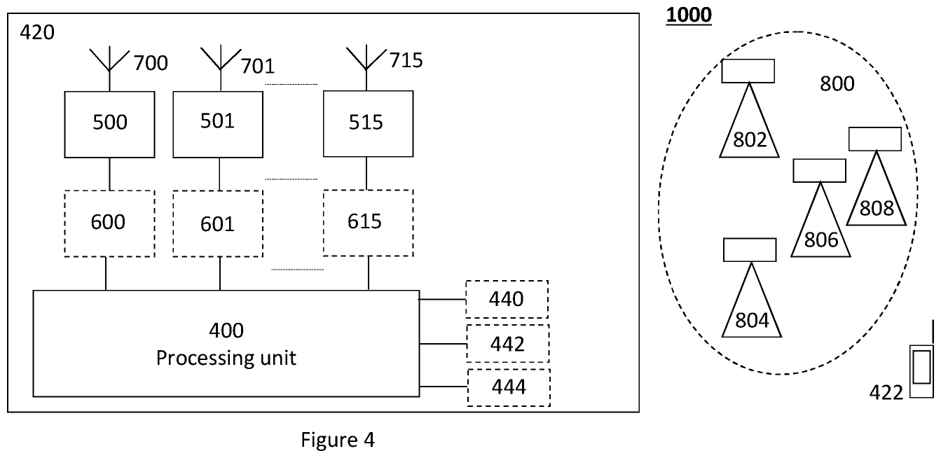

In the following, embodiments will be described where FIG. 1 illustrates method steps according to some embodiments. The method 100 is for a processing unit 400 (shown in FIG. 4). The processing unit 400 is associated with (connected or connectable to) and able to control a plurality of transceivers 500, 501, . . . , 515 (shown in FIG. 4). Furthermore, the processing unit 400 is configured to control the plurality of transceivers 500, 501, . . . , 515. In some embodiments, the processing unit 400 is connected or connectable to the plurality of transceivers 500, 501, . . . , 515 via analog to digital converters (ADCs) 600, . . . , 615 (shown in FIG. 4). Alternatively, the processing unit 400 is connected or connectable to the plurality of transceivers 500, 501, . . . , 515 directly. Furthermore, in some embodiments, the transceivers 500, 501, . . . , 515 are connected or connectable to antenna units 700, . . . , 715 (shown in FIG. 4). In some embodiments, a wireless device (WD) 420 (shown in FIG. 4) comprises the processing unit 400 and/or the plurality of transceivers 500, 501, . . . , 515, i.e., the processing unit 400 and/or the plurality of transceivers 500, 501, . . . , 515 are comprisable or comprised in the WD 420. Furthermore, in some embodiments, the plurality of transceivers 500, 501, . . . , 515 distributed over a space, such as over a space of a printed circuit board (PCB), such as a PCB comprised in the WD 420. In some embodiments, the WD 420 has digital beamforming capabilities. Furthermore, in some embodiments, the processing unit 400 is configured for performing millimeter wave (mmW) multiple-input multiple-output (MIMO) and/or beamforming towards a set of (remote) TNodes 422, 802, 804, 806, 808 (shown in FIG. 4). The method comprises obtaining 110 a configuration associated to/with measurement occasions for a first TNode 422, 802, 804, 806, 808, e.g., measurement occasions during/at/on which the WD 420 can perform measurements for (e.g., related to or associated with) a first TNode 422, 802, 804, 806, 808. In some embodiments the first TNode 422, 802, 804, 806, 808 is a serving base station, BS, 802 for a deactivated secondary cell, SCell. Alternatively, the first TNode 422, 802, 804, 806, 808 is a serving BS 804 associated with a configured TCI state. As another alternative, the first TNode 422, 802, 804, 806, 808 is a handover, HO, candidate BS 806. As yet another alternative, the first TNode 422, 802, 804, 806, 808 is a serving BS 808 associated with an active Transmission Configuration Indicator (TCI) state. In some embodiments, the configuration associated to/with measurement occasions is obtained from the first TNode 422, 802, 804, 806, 808. Moreover, in some embodiments, the configuration associated to/with the measurement instances/occasions may be obtained from Channel State Information Reference Signal (CSI-RS) time occasions or from Synchronization Signal Block (SSB) index time occasions. In some embodiments, the measurement occasions (or the configuration associated therewith) are obtained from a gNB configuration, or from a pre-defined rule (e.g., defined in a standard, such as a 5G-NR standard), which may be stored in a look-up table (LUT) comprised in the WD 420, or a combination thereof. Alternatively, the configuration associated to/with the measurement occasions is obtained by checking all possible measurement occasions. The measurement occasions are the instants at which the WD 420 can find CSI-RS, SSB or similar to perform measurement on. In some embodiments, the measurement occasions are synchronization signal block, SSB, index time occasions. Alternatively, or additionally, the measurement occasions are channel state information, CSI-RS, time occasions. Furthermore, alternatively, or additionally, the measurement occasions are demodulation reference signal, DM-RS, time occasions. The method comprises obtaining 120 a number N indicative of how many measurement occasions are available for the first Tnode 422, 802, 804, 806, 808, i.e., the method comprises obtaining 120 a number N indicative of how many measurement occasions during which the WD 420 can perform measurements for the first Tnode 422, 802, 804, 806, 808 are available. In some embodiments, the number N indicative of how many measurement occasions are available for the first TNode 422, 802, 804, 806, 808 is obtained from a configuration obtained from a second Tnode 802, 804, 808. Additionally, or alternatively, the number N is obtained from a pre-defined rule, wherein the pre-defined rule is based on a type of TNode (e.g., TNode for an intra- or inter-frequency neighbour cell or a serving TNode) for the first Tnode 422, 802, 804, 806, 808 (i.e., based on/in accordance with a transceiver node type of the first Tnode). In some embodiments, the second TNode 802, 804, 808 is a serving BS. Furthermore, in some embodiments, the first and second TNodes are the same TNode. Moreover, in some embodiments, the number N is obtained from a standard (e.g., 5G-NR), from the first Tnode 422, 802, 804, 806, 808 or from a determination made by the WD 420, e.g., based on current radio channel conditions, e.g., based on information such as SINR for various Tnodes or the type of TNode (e.g., TNode for an intra- or inter-frequency neighbour cell or a serving TNode) the first Tnode 422, 802, 804, 806, 808 is. In some embodiments, there are 8 or 24 measurement occasions available for the first Tnode 422, 802, 804, 806, 808. Moreover, the method comprises allocating 130, e.g., by a control unit (comprised in the WD 420 and/or connected/connectable to the processing unit 400), for each of the available measurement occasions a subset of the plurality of transceivers 500, 501, . . . , 515, based on the obtained number N. In some embodiments, the subset of the plurality of transceivers 500, 501, . . . , 515 is selected based on the WD position (and thus the transceiver positions for the transceivers therein) relative the position of the first Tnode 422, 802, 804, 806, 808. Furthermore, a subset of the plurality of transceivers 500, 501, . . . , 515 may be empty, i.e., one or more measurement occasions may not have any transceivers allocated. Thus, for a subset or for all of the plurality of transceivers 500, 501, . . . , 515 reception for measurements is/can be turned off (e.g., during one or more of the available measurement occasions for which the allocated subset is empty or during all of the available measurement occasions for which the allocated subset is empty) and thus power consumption is reduced. In some embodiments, turning off reception for measurements for a transceiver comprises turning off one or more front end transceivers associated with (e.g., connected or connectable to) the same transceiver. Alternatively, or additionally, turning off reception for measurements for a transceiver comprises turning off one or more of a low noise amplifier (LNA), a variable gain amplifier (VGA), a phase locked loop (PLL), a power amplifier (PA), a local oscillator (LO), and a mixer, all associated with the (same) transceiver, e.g., turning off the low noise amplifier (LNA), the variable gain amplifier (VGA), local oscillator (LO), and a mixer and the power amplifier (PA). In some embodiments, allocating 130 for each of the available measurement occasions a subset of the plurality of transceivers 500, 501, . . . , 515 is further based on a (e.g., earlier obtained) signal quality/strength measurement for a subset of the plurality of transceivers 500, 501, . . . , 515, such as a subset of active (or virtually active) transceivers, e.g., Mu-VAAS/VATS or Mu/Ma-ATS/AAS. As an example, if the signal quality/strength is low, e.g., lower than a signal threshold value, the measurements for the subset of the plurality of transceivers utilized for signal quality/strength measurement are repeated at the (one or more) following measurement occasion. The measurements at the different measurement occasions may then be summed or averaged to obtain a more reliable measurement. If the signal quality/strength is high, e.g., higher than the signal threshold value, the measurements for the subset of the plurality of transceivers utilized for signal quality/strength measurement are not repeated at the following measurement occasion. Thus, it may be possible to not measure at all at the following measurement occasion and thus power consumption may be reduced.

Additionally, or alternatively, the allocating 130 for each of the available measurement occasions a subset of the plurality of transceivers 500, 501, . . . , 515 is further based on a TNode type. In some embodiments, if the TNode is a HO candidate all measurements are performed during only one measurement occasion (per cycle), whereas if the TNode is a serving BS measurements are performed for all transceivers and/or during a plurality of measurement occasions (per cycle). Moreover, additionally, or alternatively, the allocating 130 for each of the available measurement occasions a subset of the plurality of transceivers 500, 501, . . . , 515 is further based on power consumption constraints, and/or data interface rate constraints. In some embodiments, the control unit 400 has access to (e.g., stored) estimates of power consumption for each transceiver and a (e.g., stored) target or maximum allowed power consumption (per measurement occasion). The control unit 400 compares a sum of the power consumption of each transceiver with the target/maximum allowed power consumption and distributes measurements for the different transceivers between measurement occasions so that the target or maximum allowed power consumption is not exceeded, e.g., if not all transceivers 500, 501, . . . , 515 but only a subset of transceivers can be enabled at the same time. Furthermore, in some embodiments, the allocating 130 for each of the available measurement occasions a subset of the plurality of transceivers is further based on data interface rates constraints. An interface between two chips (e.g., between a digital interface chip and a baseband chip) may have constraints in data rates. Then allocating 130 may be performed under the condition that a maximum interface capacity is not exceeded.

The method comprises performing 140 at each (available) measurement occasion, the measurements relating to the subset allocated to the (available) measurement occasion, thereby obtaining e.g., a signal measurement, such as a (received) signal strength measurement and/or a (received) signal quality measurement, associated to/with the first Tnode 422, 802, 804, 806, 808. The signal strength (measurements) may comprise one or more of received power (RP), such as one or more of a reference signal received power (RSRP), a secondary synchronization signal reference signal received power (SS-RSRP), a channel state information reference symbols reference signal received power (CSI-RS RSRP) and a Layer 1 reference signal received power (L1-RSRP), or a received signal strength indication, such as received signal strength indicator (RSSI). Preferably the signal strength comprises/is an RSRP. The signal quality (measurements) may comprise one or more of received quality (RQ), such as reference signals received quality (RSRQ), secondary synchronization signal reference signal received quality (SS-RSRQ), channel state information reference symbols reference signal received quality (CSI-RS RSRQ), signal to noise ratio (SNR), or signal to interference and noise ratio (SINR), such as secondary synchronization signal to interference and noise ratio (SS-SINR) or Layer 1 signal to interference and noise ratio (L1-SINR).

In some embodiments, the size of a/each subset of the plurality of transceivers 500, 501, . . . , 515 is based on one or more of a (e.g., earlier obtained) signal quality/strength measurement for a subset of the plurality of transceivers 500, 501, . . . , 515, such as a subset of active (or virtually active) transceivers, e.g., Mu-VAAS/VATS or Mu/Ma-ATS/AAS. As an example, if the signal quality/strength is low, e.g., lower than a signal threshold value, the subset of the plurality of transceivers 500, 501, . . . , 515 utilized for signal quality/strength measurement is extended for the next measurement occasion (e.g., by including more transceivers in the subset). If the signal quality/strength is high, e.g., higher than the signal threshold value, the subset of the plurality of transceivers utilized for signal quality/strength measurement is either restricted or kept the same for the next measurement occasion (e.g., by excluding more transceivers in the subset or by keeping the subset unchanged). Thus, it may be possible to measure with fewer transceivers and thus power consumption may be reduced.

Additionally, or alternatively, the size of a/each subset of the plurality of transceivers is based on a TNode type. In some embodiments, if the Tnode 422, 802, 804, 806, 808 is a HO candidate BS 806 all measurements are performed with only a few transceivers, such as 2, whereas if the Tnode 422, 802, 804, 806, 808 is a serving BS 802, 804, 808 measurements are performed for more, such as 3, or all, transceivers. Moreover, additionally, or alternatively, the size of a/each subset of the plurality of transceivers 500, 501, . . . , 515 is based on power consumption constraints, and/or data interface rate constraints. In some embodiments, the control unit 400 has access to (e.g., stored) estimates of power consumption for each transceiver and a (stored) target or maximum allowed power consumption (per measurement occasion). The control unit 400 compares a sum of the power consumption of each transceiver with the target/maximum allowed power consumption and determines the size of the/each subset (i.e., how many transceivers that belong to the subset) so that the target or maximum allowed power consumption is not exceeded, e.g., if not all transceivers 500, 501, . . . , 515 but only a subset of transceivers can be enabled at the same time. As an example, if there are 16 transceivers distributed around the PCB, but only 8 can be utilized at the same time without exceeding the target/maximum allowed power consumption, then only 8 transceivers are enabled at the same time. Furthermore, in some embodiments, the size of a/each subset of the plurality of transceivers 500, 501, . . . , 515 is based on data interface rates constraints. An interface between two chips (e.g., between a digital interface chip and a baseband chip) may have constraints in data rates. Then the size of the/each subset (i.e., how many transceivers that belong to the subset) may be determined under the condition that a maximum interface capacity is not exceeded.

Moreover, in some embodiments, the method further comprises transmitting 150 a measurement report to the second Tnode 802, 804, 808. The measurement report comprises a signal quality/strength measurement value. In some embodiments, signal quality/strength measurements for each transceiver of a first subset of the plurality of transceivers are combined (e.g., summed or averaged) into the signal quality/strength measurement value. The transmitting 150 may be performed periodically, or upon an event detected, such as when a measurement for a particular TNode fulfils a condition. In some embodiments, the condition is that the signal quality/strength measurement value of the particular TNode exceeds a threshold value. The threshold value may be fixed or adaptive. Moreover, the threshold value may be based on a (signal) measurement of another TNode. E.g., a measurement of a another/primary TNode has generated a certain value, which is utilized as the threshold value. Furthermore, the threshold value may be configured by the particular TNode or defined in a standard, such as a 5G-NR standard. Alternatively, or additionally, the condition is configured by the particular TNode. Furthermore, alternatively, or additionally, the condition is pre-determined by a standard, such as a 5G-NR standard.

Furthermore, in some embodiments, the first subset is a subset providing a minimum/mean/median of signal quality/strength over all subsets of the plurality of transceivers 500, 501, . . . , 515. Alternatively, the first subset is a subset maximizing the signal quality/strength over all subsets of the plurality of transceivers 500, 501, . . . , 515. Moreover, in some embodiments, the measurement report comprises a measurement set of one or more measurements for one or more Tnodes 422, 802, 804, 806, 808.

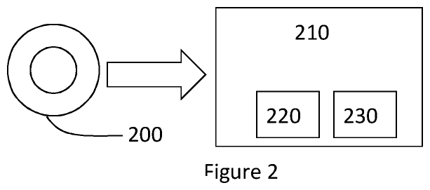

According to some embodiments, a computer program product comprising a non-transitory computer readable medium 200, such as a punch card, a compact disc (CD) ROM, a read only memory (ROM), a digital versatile disc (DVD), an embedded drive, a plug-in card, or a universal serial bus (USB) memory, is provided. FIG. 2 illustrates an example computer readable medium in the form of a compact disc (CD) ROM 200. The computer readable medium has stored thereon, a computer program comprising program instructions. The computer program is loadable into a data processor (PROC) 220, which may, for example, be comprised in a computer 210 or a computing device or the processing unit 400. When loaded into the data processor, the computer program may be stored in a memory (MEM) 230 associated with or comprised in the data processor. According to some embodiments, the computer program may, when loaded into and run by the data processor, cause execution of method steps according to, for example, the method illustrated in FIG. 1, which is described herein. Furthermore, in some embodiments, there is provided a computer program product comprising instructions, which, when executed on at least one processor of a processing device, cause the processing device to carry out the method illustrated in FIG. 1. Moreover, in some embodiments, there is provided a non-transitory computer-readable storage medium storing one or more programs configured to be executed by one or more processors of a processing device, the one or more programs comprising instructions which, when executed by the processing device, causes the processing device to carry out the method illustrated in FIG. 1.

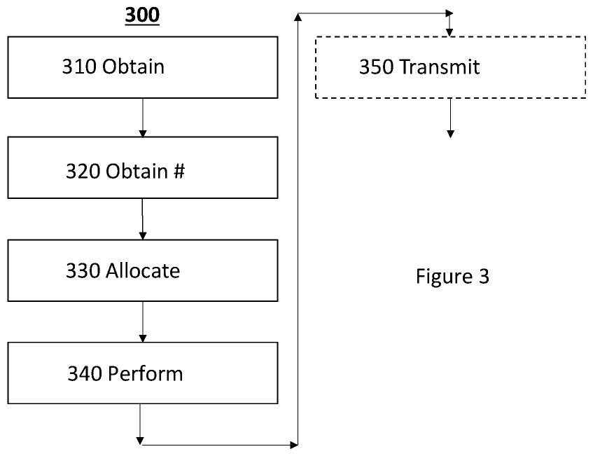

FIG. 3 illustrates method steps implemented in a processing unit 400 (shown in FIG. 4 and described in connection therewith) according to some embodiments. The processing unit 400 is associated with (connected or connectable to) a plurality of transceivers 500, 501, . . . , 515 (shown in FIG. 4). Furthermore, the processing unit 400 is able to control or controls the plurality of transceivers 500, 501, . . . , 515. Moreover, the processing unit 400 and the plurality of transceivers 500, 501, . . . , 515 are comprised or comprisable in a wireless device (WD) 420. The processing unit 400 is configured to obtain 310 a configuration associated to/with measurement occasions during which the WD 420 can perform measurements for a first TNode 422, 802, 804, 806, 808. To this end, the processing unit 400 may be associated with (e.g., operatively connectable, or connected, to) one or more first obtainment units (e.g., first obtaining circuitry or a plurality of receivers/transceivers 500, 501, . . . , 515). The processing unit 400 is configured to obtain 320 a number N indicative of how many measurement occasions, during which the WD 420 can perform measurements for the first TNode, are available. To this end, the processing unit 400 may be associated with (e.g., operatively connectable, or connected, to) one or more second obtainment units (e.g., second obtaining circuitry or the plurality of receivers/transceivers 500, 501, . . . , 515). Furthermore, the processing unit 400 is configured to allocate 330, for each of the available measurement occasions, a subset of the plurality of transceivers 500, 501, . . . , 515 based on the obtained number N. To this end, the processing unit may be associated with (e.g., operatively connectable, or connected, to) one or more allocation units (e.g., allocating circuitry or an allocator). Moreover, the processing unit 400 is configured to perform 340, at each measurement occasion, the measurements relating to the subset allocated to the measurement occasion. To this end, the processing unit 400 may be associated with (e.g., operatively connectable, or connected, to) one or more measurement units (e.g., measuring circuitry or a measurer). One or more allocated subsets are empty. Moreover, reception for measurements is turned off for all of the plurality of transceivers 500, 501, . . . , 515 during one or more (or all) of the available measurement occasions for which the allocated subset is empty. Furthermore, in some embodiments, the processing unit 400 is configured to transmit 350 a measurement report to the second Tnode 802, 804, 808. To this end, the processing unit 400 may be associated with (e.g., operatively connectable, or connected, to) one or more transmission units (e.g., transmitting circuitry or the plurality of transceivers 500, 501, . . . , 515).

FIG. 4 illustrates a processing unit 400 according to some embodiments. The processing unit 400 may be comprised in a wireless device 420. E.g., a wireless device, WD, 420 comprises the processing unit 400 (e.g., the processing unit 400 as described in connection with FIG. 3 above) and a plurality of transceivers 500, 501, . . . , 515. The processing unit 400 is connected or connectable to the plurality of transceivers 500, 501, . . . , 515 directly or via analog to digital converters (ADCs) 600, . . . , 615. Furthermore, in some embodiments, the transceivers 500, 501, . . . , 515 are connected or connectable to antenna units 700, . . . , 715. The antenna units 700, . . . , 715 are external or internal units. Furthermore, the antenna units 700, . . . , 715 each may have a vertical and/or a horizontal polarization. In some embodiments, the WD 420 comprises one or more sensors. The one or more sensors may comprise one or more motion sensors 440, one or more Global Positioning System (GPS) receivers 442, one or more cameras 444, one or more gyroscopes, one or more accelerometers, one or more compasses, one or more barometers, one or more light sensors, one or more fingerprint sensors and one or more proximity sensors. Moreover, in some embodiments, the one or more sensors is utilized to determine a spatial position of the WD 420. The processing unit 400 (or a baseband processor) may then utilize the determined spatial position (of the WD 420) for selecting the subset(s) of the plurality of transceivers 500, 501, . . . , 515 (for each of the available measurement occasions). Moreover, the system 1000 comprises the WD 420, one or more second WDs 422, and a set 800 of TNodes 802, 804, 806, 808. In some embodiments, the TNode 802, 804, 806, 808 is a serving BS 802 for a deactivated secondary cell, SCell. In some embodiments, the TNode 802, 804, 806, 808 is a serving BS 804 associated with a configured TCI state. In some embodiments the TNode 802, 804, 806, 808 is a handover, HO, candidate BS 806. In some embodiments, the TNode 802, 804, 806, 808 is a serving base station, BS, 808 associated with an active Transmission Configuration Indicator (TCI) state. In some embodiments, the second WD 422 is a TNode, such as the first TNode.

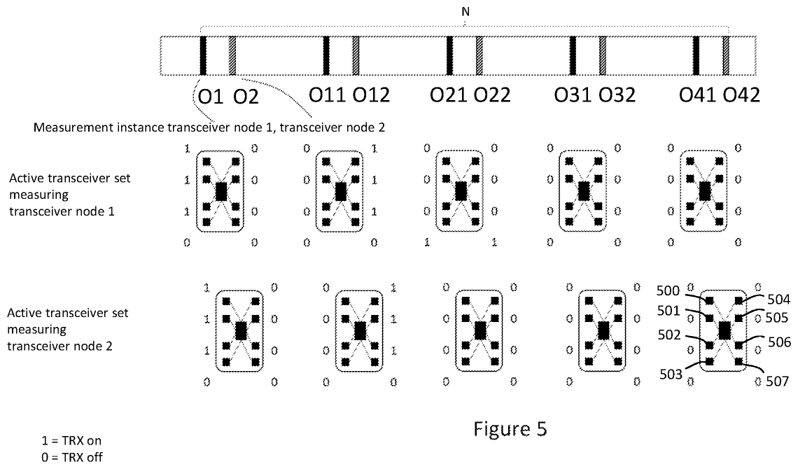

FIG. 5 illustrates which transceivers are utilized for measurements during different measurement occasions according to some embodiments. The WD 420, operating in the mmW frequency range with digital beamforming capabilities, comprises a set of transceivers 500, 501, . . . , 507 connected to antennas 700, 701, . . . , 715. For each TNode 422, 802, 804, 806, 808, which could be a serving (primary) cell, a serving (secondary active/deactivated) cell, each with a certain TCI state (TX beam), or a neighbouring cell (associated with a TCI state or a TX beam), remote radio unit (RRU), or another wireless device, a subset of the set of transceivers is allocated. An active TCI state does not formally exist for deactivated SCells or neighbour cells. However, certain reference signals (RS) that are associated with TCI states, such as SSBs and CSI-RSs, do exist. Hence in a broad sense one can consider e.g., an SSB to be associated with a TCI state, although the TCI state maybe not yet defined and not yet activated, and can use “TCI state” and “TX beam” interchangeably, where TX beam is defined by one or more of the aforementioned RSs. The subset typically depends on the TNode position relative the position and/or rotation of the WD 420. Since the WD 420 can be rotated, the direction to a TNode can change within short time, therefore the WD 420 needs to monitor TNodes not only with the current “best” subset of transceivers, but also with other (e.g., candidate) subsets of the transceivers 500, 501, . . . , 515. For each TNode the WD 420 has a certain number of measurement occasions (N) to perform a measurement on. The number is typically defined for a standard (e.g., 5G-NR) or configured by the serving TNode. In some embodiments, the number N is determined by the WD 420 itself, based on information, such as SINR to various TNodes, the type of TNode (e.g., serving TNode, intra- or inter-frequency neighbour TNode etc.). In some embodiments, a control unit (associated with the processing unit 400), based on the number of measurements allocates subset of transceivers to measure the received signal strength, RSRP, RSSI, RSRQ, SNR (on reference symbols, SSB, CSI-RS, DM-RS etc. or more generally using available physical resources/based on the received subframe) for the TNode.

In FIG. 5 transceivers 500, 501, . . . , 507 utilized for measurements are shown for two different TNodes, TNode 1 and TNode 2. As can be seen in FIG. 5 for some of the measurement occasions O22, O31, O32, O41, O42 (measurement occasions O1, O11, O21, O31, O41 are for TNode1 and measurement occasions O2, O12, O22, O32, O42 are for TNode2) there is no measurement done (measurements only performed when TRX on) and hence the WD 420 can turn off reception for measurements and save power. In some embodiments, TNode 2 has low priority, e.g., lower priority than TNode 1, e.g., because it is not a serving BS or a HO candidate BS with high signal quality, but rather a HO candidate with low signal quality, i.e., not a likely or best HO candidate. Then, as seen in FIG. 5, measurements are performed for/with only some (a few, less than all, less than for TNode 1) transceivers 500, 501, 502, 504, 505, 506 (500 in upper left corner, 503 in lower left corner, 504 in upper right corner and 507 in lower right corner as illustrated for measurement occasion O42 in the lower right corner of FIG. 5) during first and second measurement occasions O2, O12 for the TNode 2 (and no measurements are performed for transceivers 503 and 508). Furthermore, as seen in FIG. 5, for Tnode 1 measurements are performed for/with all transceivers 500, 501, . . . , 507 during the N measurement occasions O1, . . . , O41 (during each measurement period). In some embodiments, measurements are performed for/with all transceivers 500, 501, . . . , 507 during the N measurement occasions O1, . . . , O41 if TNode 1 has high priority (e.g., higher priority than TNode 2). In some embodiments, TNode 1 has high priority if TNode 1 is the serving BS, or a HO candidate BS with high signal quality, i.e., a likely or best HO candidate. Measurements in all directions from the WD 420 may then be needed in order to handle rotation of the WD 420.

Furthermore, in some embodiments, the same subset of the plurality of transceivers allocated for a TNode is allocated also for a different TNode. As shown in FIG. 5, the same transceiver subset comprising the transceivers 500, 501, 502 utilized for measurements at a first measurement occasion O1 for the TNode 1 is also utilized for measurements at a first measurement occasion O2 for the TNode 2. Furthermore, the same transceiver subset comprising the transceivers 504, 505, 506 utilized for measurements at a second measurement occasion O11 for the TNode 1 is also utilized for measurements at a second measurement occasion O12 for the TNode 2. This may be advantageous, since the TRX on/off switch rates may be reduced, thus saving power and complexity.

As an example (illustrated in FIG. 5), a WD 420 has 8 transceivers and there are 5 measurement occasions during which the WD 420 can perform measurements for a second Tnode and 5 measurement occasions during which the WD 420 can perform measurements for a first Tnode having higher priority (e.g., high priority) than the second Tnode. As the second TNode has a lower priority (e.g., low priority) than the first TNode, measurements will only be performed for a subset of the 8 transceivers. E.g., measurements will only be performed for the most important transceivers or the transceivers that are most likely to be utilized. Which transceivers measurements will be performed for may be dependent on the direction, rotation, position and or the rotational position (in relation to a base station) of the WD 420 (e.g., transceivers connected to antennas located on/at a side of the WD 420 facing the base station may be considered more likely to be utilized than transceivers connected to antennas located on/at a side of the WD 420 not facing the base station). Furthermore, as the first TNode has a high/higher priority, measurements will be performed for all of the 8 transceivers. Moreover, as there are 5 available measurement occasions during which the WD 420 can perform measurements for the first Tnode, there will be 5 subsets of transceivers. Each subset of transceivers will comprise zero, one or more transceivers. Furthermore, all transceivers will be in at least one subset (as the first TNode has high priority). FIG. 5 shows a possible distribution of subsets, where the first subset for the measurement occasion O1 comprises 3 transceivers 500, 501, 502, the second subset for the measurement occasion O11 comprises 3 transceivers 504, 505, 506, and the third subset for the measurement occasion O21 comprises 2 transceivers 503, 507, whereas all other measurement occasions associated with the first TNode have empty subsets (thereby reducing power consumption). The number of transceivers in each subset is, in some embodiments, dependent/based on (in accordance with) the computational power (of the processing unit 400) available for measurements. Thus, in some situations, the available computational power may allow a subset of 8 transceivers (at each measurement occasion), whereas in other situations, the available computational power allows a subset of only 4 transceivers (at each measurement occasion), and in yet other situations, the available computational power allows a subset of only 3 or 2 transceivers (at each measurement occasion). Thus, in some embodiments, the allocating 330, for each of the available measurement occasions, a subset of the plurality of transceivers 500, 501, . . . , 515 is based on (in accordance with) the available computational power.

As another example, a WD 420 has 8 transceivers and there are 8 measurement occasions during which the WD 420 can perform measurements for a second Tnode (e.g., having low priority) and 8 measurement occasions during which the WD 420 can perform measurements for a first Tnode having higher priority (e.g., high priority) than the second Tnode. In this example, there will be 8 subsets of transceivers. The possible distributions are the same as for the example with 5 measurement occasions for each of the first and second TNodes, with the difference that not only the subsets allocated to the measurement occasions O31 and O41, but also the subsets allocated to the following 3 measurement occasions (not shown in FIG. 5) are empty (and similarly for the cases with all subsets except one being empty, i.e., one or the first subset comprising 8 transceivers; all subsets except 2 being empty, i.e., two or the first and second subset comprising 4 transceivers each; and all subsets except 4 being empty, i.e., 4 subsets, e.g., the first 4 subsets, comprising 2 transceivers each.

As another example, a WD 420 has 8 transceivers and there are 24 measurement occasions during which the WD 420 can perform measurements for a second Tnode (e.g., having low priority) and 24 measurement occasions during which the WD 420 can perform measurements for a first Tnode having higher priority (e.g., high priority) than the second Tnode. In this example, there will be 24 subsets of transceivers. The possible distributions are the same as for the example with 5 measurement occasions for each of the first and second TNodes, with the difference that not only the subsets allocated for the measurement occasions O31 and O41, but also the subsets allocated to the following 19 measurement occasions are empty (and similarly for the cases with all subsets except one being empty; all subsets except 2 being empty; all subsets except 4 being empty; and all subsets except 8 being empty, each non-empty subset comprising one transceiver).

The WD 420 may instead have e.g., 16 or 32 transceivers. With 16 transceivers, there may be e.g., 1, 2, 3, 4, 8 or 16 non-empty subsets and with 32 transceivers, there may be e.g., 1, 2, 3, 4, 8, or 16 non-empty subsets (depending on the number of available measurement occasions).

As can be seen from the examples above, allocating 130 for each of the available measurement occasions a subset of the plurality of transceivers is based on (in dependence on, in accordance with) the obtained number (N), since there should be fewer non-empty subsets than there are available measurement occasions (during which a WD can perform measurements for a TNode). Thus, the allocating 130 for each of the available measurement occasions a subset of the plurality of transceivers is performed under the constraint that a number of non-empty subsets cannot exceed (or be equal to) the obtained number (N).

In some embodiments, measurements for the second TNode are performed only for the transceivers that are most likely to be utilized, e.g., the transceivers in the first subset and optionally the second subset, for which measurements are performed for the first TNode.

In some embodiments/aspects, a chip 912 (not shown) is provided. The chip 912 comprises the processing unit 400 (described above). Alternatively, the chip 912 comprises a baseband processor 910. The baseband processor 910 comprises the processing unit 400. In some embodiments, the chip 912 comprises one or more of the transceivers 500, . . . , 515. Furthermore, in some embodiments, the chip 912 comprises one or more ADCs 600, . . . , 615. The WD 420 described herein may comprise the chip 912.

### LIST OF EXAMPLES

Example 1. A method (100) for a processing unit (400), the processing unit (400) being associated with and able to control a plurality of transceivers (500, 501, . . . , 515), the method comprising:
obtaining (110) a configuration associated to measurement occasions for a first transceiver node (422, 802, 804, 806, 808);
obtaining (120) a number (N) indicative of how many measurement occasions are available for the first transceiver node;
allocating (130) for each of the available measurement occasions a subset of the plurality of transceivers, based on the obtained number (N); and
performing (140) at each measurement occasion, the measurements relating to the subset allocated to the measurement occasion.

Example 2. The method of example 1, wherein the measurement occasions are one of:
synchronization signal block, SSB, index time occasions;
channel state information, CSI-RS, time occasions; and/or
demodulation reference signal, DM-RS, time occasions.

Example 3. The method of any of examples 1-2, wherein the first transceiver node (422, 802, 804, 806, 808) is any one of:
a serving base station, BS, associated with an active Transmission Configuration Indicator, TCI, state;
a serving BS associated with a configured TCI state;
a handover, HO, candidate BS; and
a serving BS for a deactivated secondary cell, SCell.

Example 4. The method of any of examples 1-3, wherein the number (N) indicative of how many measurement occasions are available for the first transceiver node is obtained from one or more of:
a pre-defined rule, wherein the pre-defined rule is based on a type of transceiver node for the first transceiver node; and
a configuration obtained from a second transceiver node.

Example 5. The method of any of examples 1-4, wherein allocating (130) for each of the available measurement occasions a subset of the plurality of transceivers is further based on one or more of:
a signal quality/strength measurement for a subset of the plurality of transceivers;
a transceiver node type;
power consumption constraints; and
data interface rate constraints.

Example 6. The method of any of examples 1-4, wherein the size of a subset of the plurality of transceivers is based on one of:
a signal quality/strength measurement for a subset of the plurality of transceivers;
a transceiver node type;
power consumption constraints; and
data interface rate constraints.

Example 7. The method of any of examples 1-6, further comprising:
transmitting (150) a measurement report to the second transceiver node, the measurement report comprising a signal quality/strength measurement value, such as signal quality/strength measurements for each transceiver of a first subset of the plurality of transceivers combined into one signal quality/strength measurement value.

Example 8. A computer program product comprising a non-transitory computer readable medium (200), having stored thereon a computer program comprising program instructions, the computer program being loadable into a data processing unit (220) and configured to cause execution of the method of any of examples 1-7 when the computer program is run by the data processing unit.

Example 9. A processing unit (400), the processing unit (400) being associated with and able to control a plurality of transceivers (500, 501, . . . , 515), the processing unit (400) being configured to:
obtain (310) a configuration associated to measurement occasions for a first transceiver node (422, 802, 804, 806, 808);
obtain (320) a number (N) indicative of how many measurement occasions are available for the first transceiver node (422, 802, 804, 806, 808);
allocate (330), for each of the available measurement occasions, a subset of the plurality of transceivers (500, 501, . . . , 515) based on the obtained number (N); and
perform (340), at each measurement occasion, the measurements relating to the subset allocated to the measurement occasion.

Example 10. A wireless device, WD, (420) comprising the processing unit (400) of example 9 and the plurality of transceivers (500, 501, . . . , 515).

Generally, all terms used herein are to be interpreted according to their ordinary meaning in the relevant technical field, unless a different meaning is clearly given and/or is implied from the context in which it is used. Reference has been made herein to various embodiments. However, a person skilled in the art would recognize numerous variations to the described embodiments that would still fall within the scope of the claims. For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step. In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer e.g., a single) unit. Any feature of any of the embodiments/aspects disclosed herein may be applied to any other embodiment/aspect, wherever suitable. Likewise, any advantage of any of the embodiments may apply to any other embodiments, and vice versa. Hence, it should be understood that the details of the described embodiments are merely examples brought forward for illustrative purposes, and that all variations that fall within the scope of the claims are intended to be embraced therein.

1. A method for a processing unit, the processing unit is configured to control a plurality of transceivers, wherein the processing unit and the plurality of transceivers are comprisable in a wireless device (WD), the method comprising:
obtaining a configuration associated with measurement occasions during which the WD can perform measurements for a first transceiver node (TNode);
obtaining a number indicative of how many measurement occasions, during which the WD can perform measurements for the first TNode, are available;
allocating for each of the available measurement occasions a subset of the plurality of transceivers or no transceivers, based on the obtained number and based on whether the first TNode is a handover (HO) candidate base station (BS) or a serving BS; and
performing at each available measurement occasion, the measurements relating to the subset allocated to the available measurement occasion,
wherein reception for measurements is turned off for all of the plurality of transceivers during one or more of the available measurement occasions for which no transceivers are allocated.

2. The method of claim 1, wherein the measurement occasions are synchronization signal block (SSB) index time occasions, channel state information (CSI-RS) time occasions, or demodulation reference signal (DM-RS) time occasions.

3-4. (canceled)

5. The method of claim 1, wherein the first TNode transceiver node is a serving base station (BS) associated with an active Transmission Configuration Indicator (TCI) state, or wherein the first TNode is a serving base station (BS) associated with a configured TCI state.

6. (canceled)

7. The method of claim 1, wherein the first TNode is a handover (HO) candidate base station (BS).

8. The method of claim 1, wherein the first TNode is a serving base station (BS) for a deactivated secondary cell (SCell).

9. The method of claim 1, wherein the number indicative of how many measurement occasions during which the WD can perform measurements for the first TNode are available is obtained from a pre-defined rule, wherein the pre-defined rule is based on whether the first TNode is an intra-frequency neighbour cell TNode, an inter-frequency neighbour cell TNode, or a serving TNode.

10. The method of claim 1, wherein the number indicative of how many measurement occasions during which the WD can perform measurements for the first TNode are available is obtained from a configuration obtained from a second TNode.

11. The method of claim 1, wherein allocating for each of the available measurement occasions a subset of the plurality of transceivers is further based on a signal quality/strength measurement for a subset of the plurality of transceivers.

12. (canceled)

13. The method of claim 1, wherein allocating for each of the available measurement occasions a subset of the plurality of transceivers is further based on power consumption constraints.

14. The method of claim 1, wherein allocating for each of the available measurement occasions a subset of the plurality of transceivers is further based on constraints in data rates between a digital interface chip comprised by the WD and a baseband chip 912 comprised by the WD.

15. The method of claim 1, wherein a size of each subset of the plurality of transceivers is based on a signal quality/strength measurement for a subset of the plurality of transceivers.

16. The method of claim 1, wherein a size of each subset of the plurality of transceivers is based on whether the first TNode is a serving BS or an HO candidate BS, and wherein if the first Tnode is a serving BS the measurements are performed for more transceivers than if the first Tnode is an HO candidate BS.

17. The method of claim 1, wherein a size of each subset of the plurality of transceivers is based on power consumption constraints.

18. The method of claim 1, wherein a size of each subset of the plurality of transceivers is based on constraints in data rates between a digital interface chip comprised by the WD and a baseband chip comprised by the WD.

19. The method of claim 10, further comprising:
transmitting a measurement report to the second TNode, the measurement report comprising a signal quality/strength measurement value.

20. The method of claim 19, wherein the signal quality/strength measurement value is obtained by combining one or more signal quality/strength measurements for each transceiver of a first subset of the plurality of transceivers.

21. The method of claim 1, wherein all transceivers of the plurality of transceivers not belonging to any of the subsets allocated to the available measurement occasions are turned off during all the measurement occasions during which the WD can perform measurements for the first TNode.

22. The method of claim 1, wherein reception for measurements is turned off for all of the plurality of transceivers during each of the available measurement occasions for which no transceivers are allocated.

23-24. (canceled)

25. A processing unit, the processing unit being associated with and able to control a plurality of transceivers, wherein the processing unit and the plurality of transceivers are comprisable in a wireless device (WD), the processing unit being configured to:
obtain a configuration associated to measurement occasions during which the WD can perform measurements for a first transceiver node (TNode);
obtain a number indicative of how many measurement occasions, during which the WD can perform measurements for the first TNode, are available;
allocate, for each of the available measurement occasions, a subset of the plurality of transceivers or no transceivers based on the obtained number and based on whether the first TNode is a handover (HO) candidate base station (BS) or a serving BS; and
perform, at each measurement occasion, the measurements relating to the subset allocated to the measurement occasion,
wherein reception for measurements is turned off for all of the plurality of transceivers during one or more of the available measurement occasions for which no transceivers are allocated.

26. A wireless device (WD) comprising the processing unit of claim 25 and the plurality of transceivers.

27. (canceled)
